(19) United States
(12) Patent Application Publication
(10) Pub. No.: US 2006/0271947 A1
(43) Pub. Date: Nov. 30, 2006

(54) Creating fingerprints

(76) Inventors: Rainer W. Lienhart, Friedberg (DE); Christine Lienhart, Friedberg (DE)

Correspondence Address: TECHNOLOGY, PATENTS AND LICENSING, INC., 2003 South EASTON ROAD, SUITE 208, DOYLESTOWN, PA, 18901, US

(21) Appl. No.: 11/135,135

(22) Filed: May 23, 2005

(51) Int. Cl. H04H 9/00; H04N 7/16; G11B 27/00; H04N 9/74; G06K 9/00

(52) U.S. Cl. 725/19; 715/723; 348/578; 382/181

(57) ABSTRACT

A method and system for the determination of new video segments is presented in which candidate sequences are recognized and stored, and analysis is performed on fingerprints of segments of the candidate sequences to isolate repeating video sequences, without prior knowledge of those repeating sequences. The repeating sequences are then added to a fingerprint library.

### BACKGROUND

Video processing systems can support the automated detection of advertisements through comparison of segments, frames, or sub-frames of an incoming video stream against a stored library of known advertisements. The comparison can be accomplished using a number of techniques including matching of video fingerprints in the incoming stream against video fingerprints in a stored library of advertisements. When the matching between the video fingerprints in the incoming stream and the video fingerprints in the stored library of advertisements is sufficiently high, it is determined that an advertisement is present in the incoming stream. In order to perform this process, it is necessary to have a stored library of advertisements, and to update that library of advertisements. What is required is a method and system for adding video sequences such as advertisements, or introductions or exits from advertisement breaks (intros and outros respectively) to a video library, without prior knowledge of those video sequences.

### SUMMARY

An incoming video stream is monitored and candidate sequences are extracted based on features within the video stream. In one embodiment the features are hard cuts in the video stream, and when the number of hard cuts exceeds a specified threshold in a video sequence, that sequence is stored as a sequence of interest (e.g. potential advertisement). Fingerprints are generated from subsequences in that video sequence, and those fingerprints are compared against other stored fingerprints. When fingerprints from the various stored sequences are found to match, it is concluded that the corresponding subsequences are repeating subsequences such as those found in advertisements. Repeating subsequences are grouped together to create an advertisement, or video fingerprint of that advertisement, that is entered into the video library. In one embodiment repeating sequences are shown to a viewer/editor and irrelevant sequences (e.g. repeating sequences in television shows as opposed to advertisements) are eliminated. The method and system can be applied to find other types of repeating sequences including repeated programs, news segments, and music videos. The method and system does not rely on a priori knowledge of the video segments.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 illustrates a Unified Modeling Language (UML) use-case diagram for a sequence detection system;

FIG. 2 illustrates an activity diagram for sequence selection;

FIG. 3 illustrates an activity diagram for sequence isolation, grouping and storing;

FIG. 4 illustrates fingerprint matching;

FIG. 5 illustrates a representative system for implementation of the method; and

FIG. 6 illustrates methods of feature based detection and recognition.

### DETAILED DESCRIPTION OF PREFERRED EMBODIMENTS

In describing various embodiments illustrated in the drawings, specific terminology will be used for the sake of clarity. However, the embodiments are not intended to be limited to the specific terms so selected, and it is to be understood that each specific term includes all technical equivalents which operate in a similar manner to accomplish a similar purpose.

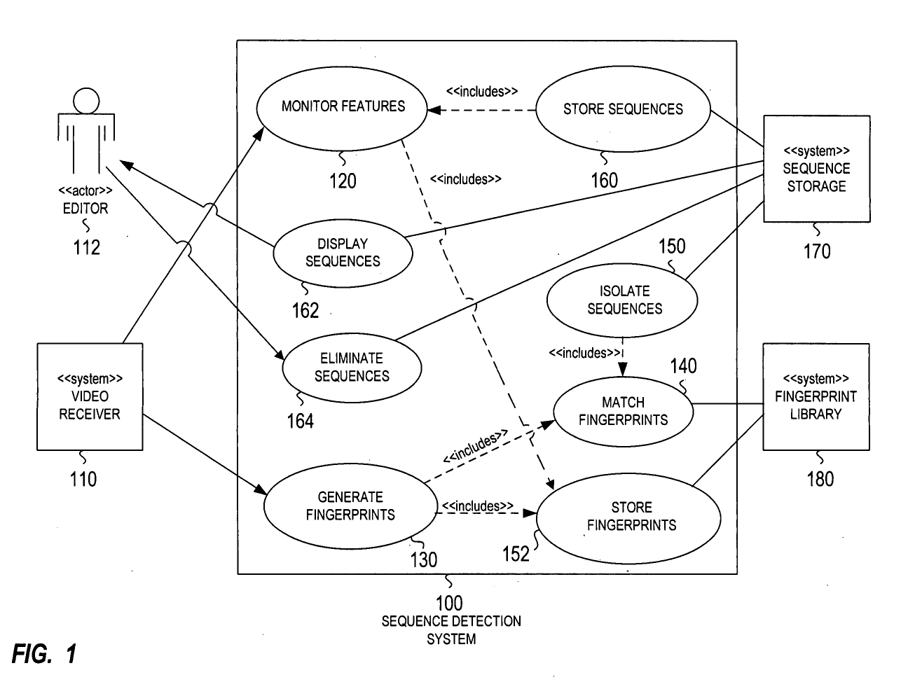

FIG. 1 illustrates a Unified Modeling Language (UML) description of the method and system. UML provides a standardized notation that can be used to describe the method and system described herein but does not constrain implementation and is not meant to limit the invention. Referring to FIG. 1 Sequence Detection System 100 interacts with a Video Receiver 110 through a Monitor Features use case 120 and a Generate Fingerprints use case 130. Monitor Features use case 120 provides for the detection of candidate sequences through feature based detection of the video stream. Sequences that are determined by Monitor Features use case 120 to have one or more features that indicate that the sequence is of interest are stored by Store Sequences use case 160 in a Sequence Storage system 170.

Video fingerprints are generated for the stored sequences in a Generate Fingerprints use case 130, and stored in a Fingerprint Library system 180 through a Store Fingerprints use case 152. A Match Fingerprints use case 140 determines which fingerprints of the candidate sequences match, and is used by the Isolate Sequences use case 150 to determine and isolate sequences, as the sets of matching fingerprints form repeating video sequences. The Isolate Sequences use case 150 creates, based on the sets of matching fingerprints, video sequences that are determined to be repeating video sequences such as advertisements. These sequences are identified as such in Fingerprint Library 180.

In one embodiment, and as illustrated in FIG. 1, an editor 112 interfaces with Sequence Detection System 100 and is presented sequences through a Display Sequences use case 162. In this embodiment editor 112 can eliminate sequences through an Eliminate Sequences use case 164 which will cause deletion from Sequence Storage system 170. This is useful when particular types of sequences (e.g. advertisements) are of interest but other repeating sequences (e.g. repeating video sequences from programming or program promotions) are not of interest. In this case all repeating sequences can be put into a sorted list and presented to editor 112. A sorted list of repeating sequences is created, and the editor 112 views the sequences and eliminates those not of interest. Corresponding fingerprints exist for sequences that have been marked as not being relevant or not of interest, and those corresponding fingerprints are used to insure that non-relevant sequences are not presented to the editor 112. Non-relevant sequences can also be eliminated from Sequence Storage system 170 through Eliminate Sequences 164. In this embodiment the list of repeating sequences gets smaller as the user classifies the video sequences.

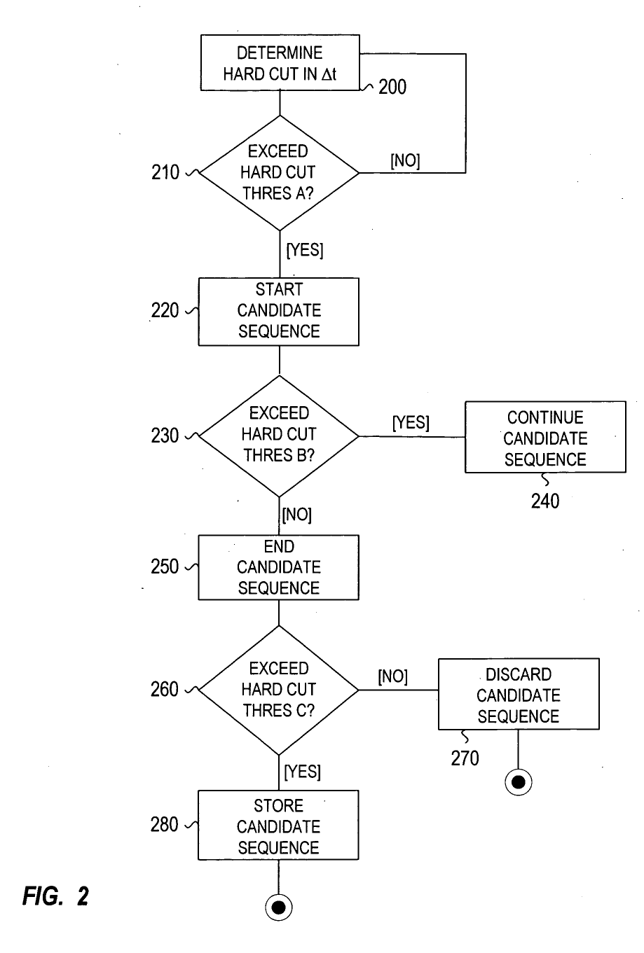

FIG. 2 illustrates a UML activity diagram for sequence isolation in which a first step of Determine Hard Cuts in Δt 200 is used to measure a particular feature such as the number of hard cuts in a sequence of duration Δt. If a specified number of hard cuts in Δt is detected through an Exceed Hard Cut Threshold A test 210, a capture of the sequence is initiated in Start Candidate Sequence step 220. If the number of hard cuts does not exceed Threshold A, the number of hard cuts continues to be monitored in Determine Hard Cuts in Δt 200. During the capture of the sequence, an Exceed Hard Cut Threshold B test 230 is performed to determine if the hard cut threshold is being maintained. In one embodiment Threshold A is intentionally set lower than Threshold B to insure that sequence capture is initiated. In this embodiment, if the hard cut frequency exceeds Threshold B the candidate sequence continues to be captured in a Continue Candidate Sequence step 240. When the hard cut frequency drops below Threshold B as detected in Exceed Hard Cut Threshold B test 230, the candidate sequence capture finishes in End Candidate Sequence step 250.

Referring again to FIG. 2 an additional Exceed Hard Cut Threshold C test 260 can be performed to determine if the candidate sequence should be stored. In one embodiment, Threshold C is set above both Threshold A and Threshold B because the types of candidate sequences of interest (intros, outros, and ads) have higher average hard cut frequencies than other sequences. If the average hard cut frequency exceeds Threshold C as determined in Exceed Hard Cut Threshold C test 260, the candidate sequence is stored in Store Candidate Sequence step 280. If the average hard cut frequency does not exceed Threshold C as determined in Exceed Hard Cut Threshold C test 260, the sequence is discarded in a Discard Candidate Sequence step 270. By setting both Threshold A and Threshold B lower than Threshold C the system captures all possible sequences of interest, and then eliminates what it determines are falsely detected sequences or sequences not of interest.

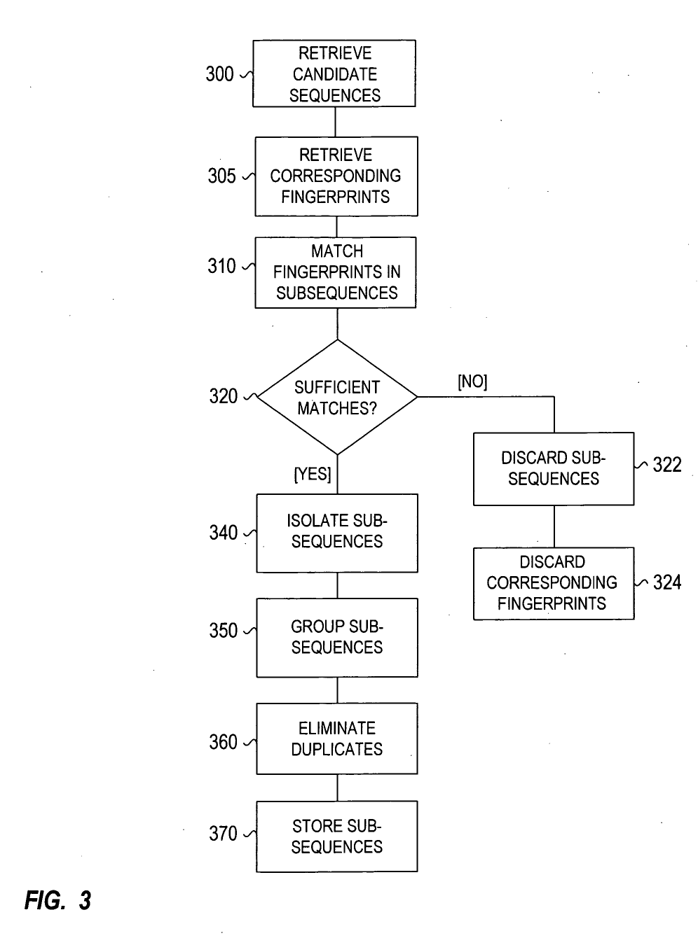

FIG. 3 illustrates a UML activity diagram for the isolation and grouping of matching sequences. At least two video sequences are retrieved from the Sequence Storage system 170 in a Retrieve Sequences step 300. Corresponding fingerprints are retrieved in a Retrieve Corresponding Fingerprints step 305. Indexed fingerprints already in the database of a subsequence length (e.g. 25 frames) are compared at a particular step size (e.g. 5 frames) against all fingerprints associated with the candidate sequences in a Match Fingerprints in Subsequences step 310. If there are insufficient matches as determined in a Sufficient Matches test 320 ([NO]) the subsequences are discarded in a Discard Subsequence step 322 and the corresponding fingerprints are discarded in a Discard Corresponding Fingerprints step 324.

If, as in illustrated in FIG. 3, there are sufficient matches as determined by Sufficient Matches test 320, (as in indicated by [YES]) an Isolate Subsequences step 340 is performed in which the subsequences (e.g. frames) that have matches are isolated to create a video sequence/segment that has been determined to be repeating. In a Group Subsequences step 350 all of the repeating subsequences are grouped together to form a set of video sequences/segments that are known to be repeating. In the case of advertisements, these would be all of the occurrences of repeating advertisements. Duplicate sequences and fingerprints (maintaining only a single copy) are eliminated in Eliminate Duplicates step 360. In a Store Subsequence step 370 the video fingerprints and/or the identified repeating video sequence itself is stored in Fingerprint Library 180.

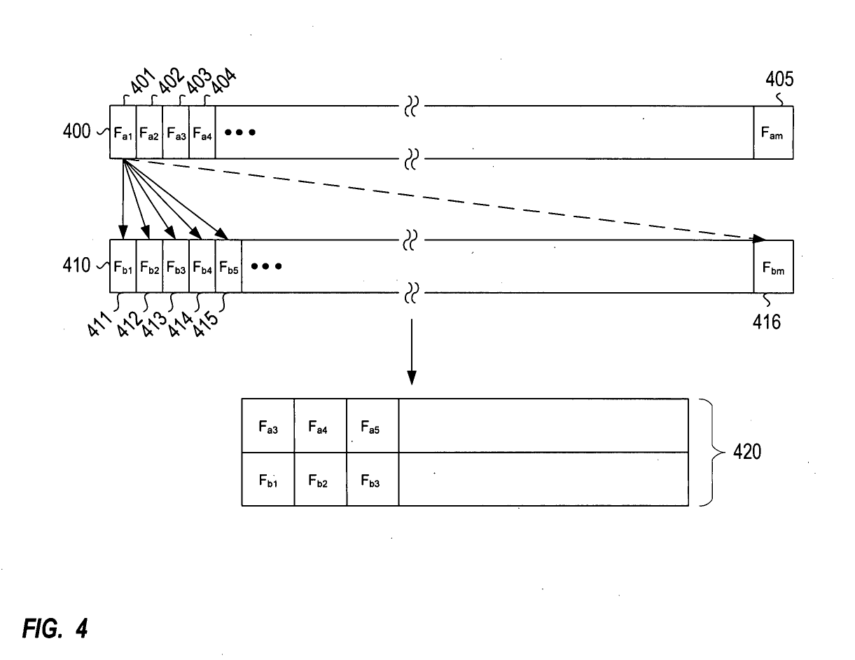

FIG. 4 illustrates how fingerprints Fₐ₁, Fa₂, Fa₃ and Fa₄ (401, 402, b and 404 respectively) in a first video sequence 400 are compared against fingerprints F_{b1}, F_{b2}, F_{b3}, F_{b4}, and F_{b5} (411, 412, 413, 414 and 415 respectively) in a second video sequence 410. As a result of the comparison, it may be determined that certain fingerprints match as illustrated by matched subsequence 420. In the case of advertisements, it may be the case that the first video sequence 400 contains an advertisement that is contained within the second video sequence 410 but is time-shifted. By comparing each fingerprint of the first video sequence 400 (Fₐ₁ 401 through Fₐₙ 405) with each fingerprint of the second video sequence 410, illustrated in FIG. 4 by the comparison of Fₐ₁ 401 with F_{b1} 411 through F_{bm} 416, it is possible to identify and align matching fingerprints to create a matching subsequence 420. In one embodiment the matching subsequence 420 is an advertisement typically having a duration of 15, 30 or 60 seconds. Because a cross-comparison or cross-correlation is performed across all fingerprints of each video sequence (e.g. Fₐ₁ 410 of the first video sequence 400 is compared or correlated against fingerprints within the second video sequence 410, it is not necessary to have knowledge of the timing or position of the unknown video sequence.

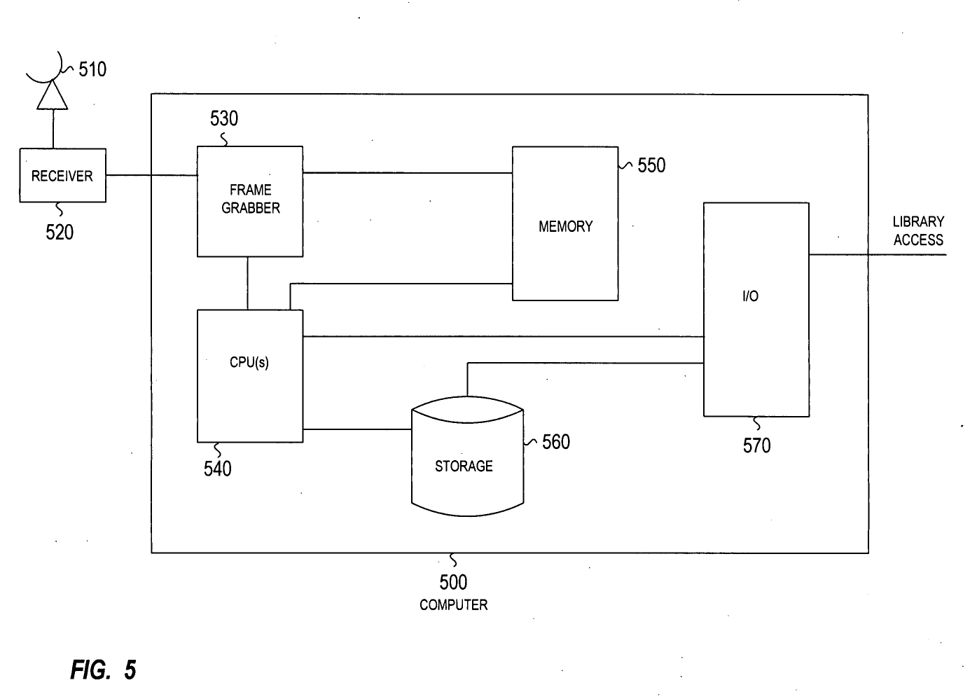

FIG. 5 illustrates a computer based system for implementation of the method and system in which a satellite antenna 510 is connected to a satellite receiver 520 which produces a video output. In one embodiment the video output is an analog signal. A computer 500 receives the video signal and a Frame Grabber 530 digitizes the input signal and stores it in memory 550. One or more CPU(s) 540 perform the signal processing steps described by FIGS. 1-3 on the incoming signal, with candidate sequences and video fingerprints being stored in storage 560. In one embodiment storage 560 is a magnetic hard drive. Library access is provided through I/O device 570. Although the input signal has been described as an analog signal from a satellite system the signal may in fact be analog or digital and can be received from any number of video sources including a cable network, a fiber-based network, a Digital Subscriber Line (DSL) system, a wireless network, or other source of video programming. The video signal may be broadcast, switched, or may be streaming or on-demand type signal. Similarly, computer 500 can be a stand-alone computer, a set-top box, a computing system within a television or other entertainment device, or other single or multiprocessor system. Storage 560 may be a magnetic drive, optical drive, magneto-optic drive, solid-state memory, or other digital or analog storage medium located internal to computer 500 or connected to computer 500 via a network.

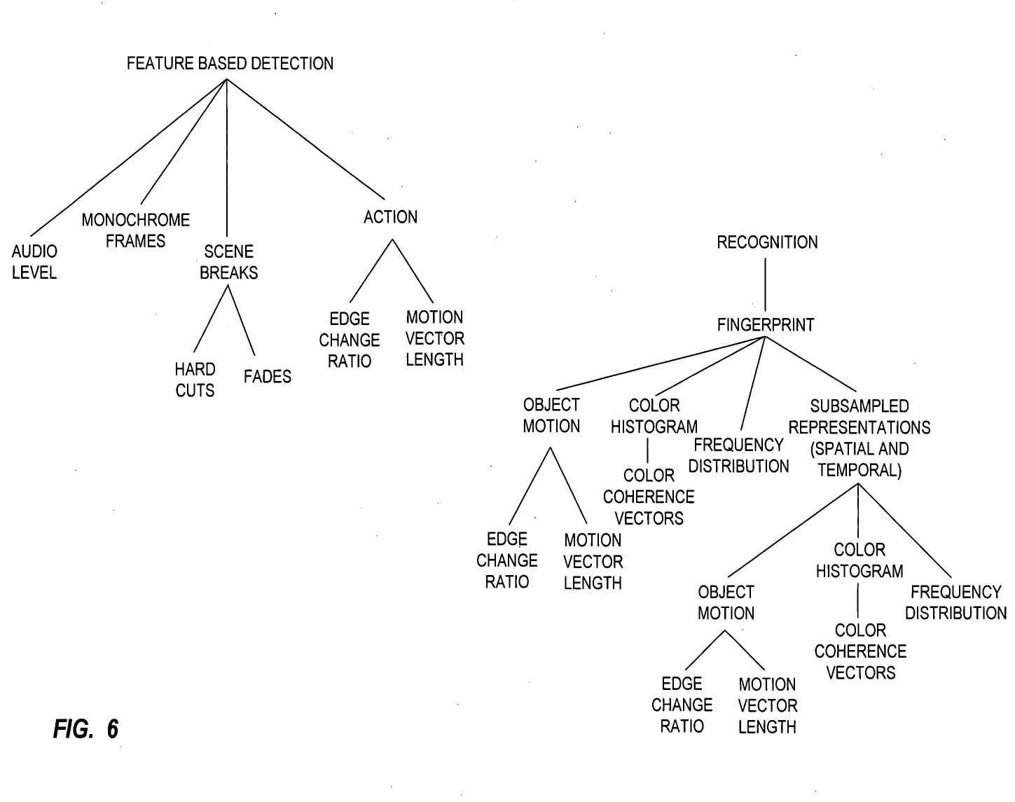

FIG. 6 illustrates the classes of feature based detection and recognition, illustrating the types of features that may be used to accomplish feature based detection and the various fingerprinting methodologies used for video sequence or segment fingerprint generation.

Referring to the left-hand side of FIG. 6 feature based detection can be accomplished utilizing a variety of features the first of which can be monochrome frames. It is well known that monochrome frames frequently appear within video streams and in particular are used to separate advertisements. Due to the presence of one or several dark monochrome frames between advertisements the average intensity of a frame or sub-frame can be monitored to determine the presence of a monochrome frame. In one embodiment multiple monochrome frames are detected to provide an indication of an ad break, set of commercials, or presence of an individual commercial. As previously discussed the presence of monochrome frames can be used to identify a candidate sequence with subsequent fingerprint recognition being utilized to determine the presence of individual advertisements. In this embodiment the presence of the monochrome frames are not used to make a final determination regarding the presence of advertisements but rather to identify a candidate sequence.

Referring again to the left-hand side of FIG. 6 scene breaks may be utilized to identify candidate sequences. Within the category of scene breaks, hard cuts, dissolves, and fades commonly occur in advertisements as well as occurring at the point at which programming ends and at which advertisements begin. Detection of hard cuts can be accomplished by monitoring color histograms, the statistics regarding the number of pixels having the same or similar color, between consecutive frames. Histogram values can be monitored for a candidate sequence or within the subsequence. A sequence having a hard cut frequency that is considered above average is a sequence likely to contain advertisements. Fades, which are the gradual transitions from one scene to another, are characterized by having a first or last frame that exhibits a standard intensity deviation that is close to zero. The transition from a scene to a monochrome frame and into another scene, characteristic of a fade, can be identified by a predictable change in intensity and in particular by monitoring standard intensity deviation. Because fade patterns have a characteristic temporal behavior (the standard intensity deviation varying linearly or in a concave manner with respect to time or frame number) the standard deviation of the intensity can be calculated and criteria established which are indicative of the presence of one or more fades. Although not illustrated in FIG. 6, dissolves can also be used as the basis for detection of the presence of ad breaks, and can, under some circumstances, be a better indicator of ad breaks than fades.

With respect to action based feature detection, action within a video sequence, including action caused not only by fast-moving objects but by hard cuts and zooms or changes in colors, can be detected by monitoring edge change ratio and motion vector length. Edge change ratio can be monitored by examining the number of entering and exiting edge pixels between images. Monitoring the edge change ratio registers structural changes in the scene such as object motion as well as fast camera operations. Edge change ratio tends to be independent of variations in color and intensity, being determined primarily by sharp edges and changes in sharp edges and thus provides one convenient means of identifying candidate sequences that contain multiple segments of unrelated video sequences.

As illustrated in FIG. 6 audio level of a signal and in particular changes in the audio level can be used to detect scene changes and advertisements. Advertisements typically have a higher volume (audio) level than programming, and changes in the audio level can serve as a method of feature based detection.

Motion vector length is useful for the determination of the extent to which object movement occurs in a video sequence. Motion vectors typically describe the movement of macro blocks within frames, in particular the movement of macro blocks within consecutive frames of video. In one embodiment compressed video such as video compressed by Motion Picture Expert Group compliant (MPEG) video compressors has motion vectors associated with the compressed video stream. Commercial block sequences or video segments containing a large number of scene changes and fast object movement are likely to have higher motion vector lengths.

Referring again to FIG. 6 recognition of video segments sequences or entities can be accomplished through the use of fingerprints, the fingerprints representing a set of statistical parameterized values associated with an image or a portion of an image from the video sequence segment or entity. One example of a statistical parameterized value that can be used as a basis for a fingerprint is the color histogram of an image or portion of an image. The color histogram represents the number of times a particular color appears within a given image or portion of an image. The color histogram has the advantage of being easy to calculate and is present for every color image.

The Color Coherence Vector (CCV) is related to the color histogram in that it presents the number of pixels of a certain color but additionally characterizes the size of the color region those pixels belong to. For example the CCV can be based on the number of coherent pixels of the same color, with coherent being defined as a connected region of pixels, the connected region having a minimum size (e.g. 8×8 pixels). The CCV is comprised of a vector describing the number of coherent pixels of a particular color as well as the number of incoherent pixels of that particular color.

As illustrated in FIG. 6, object motion, as represented by motion vector length and edge change ratio, can be used as the basis for recognition (through fingerprints or other recognition mechanisms) as derived either from the entire image or through a sub-sampled (spatial or temporal) image.

Fingerprint generation can be accomplished by looking at an entire image to produce fingerprints or by looking at sub-sampled representations. A sub-sanpled representation may be a continuous portion of an image or regions of an image which are not connected. Alternatively, temporal sub-sampled representations may be utilized in which portions of consecutive frames are analyzed to produce a color histogram or CCV. In an alternate embodiment the frames analyzed are not consecutive but are periodically or aperiodically spaced. Utilization of sub-sampled representations has the advantage that full processing of each image is not required, images are not stored (potentially avoiding copyright issues), and processing requirements are reduced. Frequency distribution, such as the frequency distribution of DCT coefficients can also be used as the basis for fingerprint recognition.

Library access can be provided on a manual or automated basis. In one embodiment, the digital library of video sequences is distributed over the Internet to other systems that are monitoring incoming video sequences for advertisements. In one embodiment the updated library is automatically distributed from storage 560 through I/O device 570 on computer 500 to a plurality of remote systems.

In one embodiment the method and system are implemented on personal computers connected to a satellite receiver. As illustrated in FIG. 2 the system identifies and isolates candidate sequences in the broadcast that could be advertisements or intro or outro segments. Intro and outro segments are used in some countries to indicate the beginning and end of advertisement breaks. Candidate sequences are isolated by monitoring the number of edit effects (e.g. changes in camera angle, scene changes, or other types of edit events) in a specified period of time on the order of 50 seconds. Because there are typically many more hard cuts in sequences containing advertisements it is possible to identify candidate sequences by monitoring the number of hard cuts: if the number of hard cuts exceeds a set threshold it is assumed that there is an ad break within that sequence, if the number of hard cuts does not exceed the threshold it is assumed that there are no advertisements (or intros/outros) in that sequence. By constantly monitoring the incoming video stream and storing candidate sequences it is possible to create a comprehensive set of candidate sequences. Rules regarding the minimum length of a candidate sequence can be applied to reduce the number of candidate clips that are kept. Video fingerprints are created and stored for each frame of video in the candidate sequence. In one embodiment a monitoring period of 24 hours is established.

The fingerprints created from the candidate sequences are compared against reference sequences as illustrated in FIGS. 3 and 4. In one embodiment, a subsequence length of 25 frames with a step factor of 5 frames is used, with fingerprints from a candidate sequence being compared, step by step, against reference search clips with a frame number X to X plus the subsequence length. Positions where matches are identified are recorded

In one embodiment candidate sequences with a number of repeats below a particular threshold (e.g. repeating less than three times in a 24 hour time period) are not stored. In an alternate embodiment any candidate sequence that is repeated more than once is stored along with the number of times it was repeated within a specified time period.

As illustrated in FIGS. 3 and 4 matching fingerprints are used to identify recurring or repeating sequences such as advertisements with the recurring or repeating sequences being stored in Sequence Storage 170, Fingerprint Library 180, or both. In one embodiment the fingerprints of the advertisements, intros, and outros are stored on storage 560 of computer 500 and subsequently distributed to other computers which are monitoring incoming video streams to identify and substitute recognized advertisements.

Fingerprint Library 180 can be disseminated to other computers and systems to provide a reference library for ad detection. In one embodiment, files are distributed on a daily basis to client devices such as computers performing ad recognition and substitution or to Personal Video Recorders (PVRs) that are also capable of recognizing, and potentially substituting and deleting the advertisements. In another embodiment Fingerprint Library 180 contains video segments of interest to users such as intros to programs of interest (e.g. a short clip common to each episode) that can be used by the users as the basis for the automatic detection and subsequent recording of programming.

For distribution of Fingerprint Library 180 text files are created for groups of fingerprints (e.g. all fingerprints for NBA basketball) with each text file holding a fingerprint name, start frame, end frame, and its categorization (into, outro, advertisement, other type of video entity, sequence or segment). In one embodiment the channel the segment appeared on is also included as well as fingerprint specific duration variables associated with the video segment. The fingerprint specific duration variables are useful for tailoring the system's behavior to the specific fingerprint being detected. For example, if it is known that the advertisement break duration is lower during one type of sporting event (e.g. boxing) versus a different type of event (e.g. football) a break duration value such as MAX_BREAK_DURATION may be stored with a fingerprint, and that value can depend on the type of programming typically associated with that advertisement.

In disseminating Fingerprint Library 180 it is useful to associate schedule information with the library including “valid from” and “valid to” dates. This information can be transmitted as a text file associated with a part or all of Fingerprint Library 180 or may be contained within Fingerprint Library 180.

In one embodiment client systems contact a central server containing Fingerprint Library 180 on a periodic basis (e.g. nightly) to ensure that they have the latest version of Fingerprint Library 180. In one embodiment the entire Fingerprint Library 180 is downloaded by each client. In an alternate embodiment the client system determines what is new in Fingerprint Library 180 and only downloads those video segments, adding them to the local copy of Fingerprint Library 180. A connection can be established between the client and the server over a network such as the Internet or other wide area, local, private, or public network. The network may be form by optical, wireless, or wired connections or combinations thereof.

As an example of the industrial applicability of the method and system described herein a central advertisement monitoring station may be created which establishes a fingerprint library based on the monitoring of a plurality of channels. In one embodiment multiple sports channels are monitored and intros, outros, and advertisements occurring on each of those channels are stored along with information related to where those video sequences or entities appeared in (e.g. channel number).

In one embodiment information related to the statistics of advertisements appearing during particular programming or on particular channels (e.g. frequency of appearance, typical ad break duration) is stored in the fingerprint library and associated with particular advertisements. The fingerprint library is periodically transmitted to client systems which consist of computers in bars and personal video recorders which then perform advertisement substitution or deletion based on the recognition of advertisements existing in the figure library.

In an alternate embodiment a central monitoring station is established to create fingerprints not only for advertisements but for particular programming including but not limited to news programs, serials and other programming which contains repeated segments. In this embodiment the central station transmits a fingerprint library which contains fingerprints for video sequences associated with programming of interest. Client systems and users of those client systems can subsequently select the types of programming that they are interested in and instruct the system to record any or all blocks of programming in which those sequences appear. For example, a subscriber may be interested in all episodes of the program “Law and Order” and can instruct their recording system (e.g. PVR) to record all blocks of programming containing the video sequence which is known to be the intro to “Law and Order.”

The method and system described herein can be implemented on a variety of computing platforms using a variety of procedural or object oriented programming languages including, but not limited to C, C++ and Java. The method and system can be applied to video streams in a variety of formats including analog video streams that are subsequently digitized, uncompressed digital video stream, compressed digital video streams in standard formats such as MPEG-2, MPEG-4 or other variants or non-standardized compression formats. The video may be broadcast, streamed, or served on an on-demand basis from a satellite, cable, telco or other service provider. The video sequence recognition function described herein may be deployed as part of a central server, but may also be deployed in client systems (e.g. PVRs or computers receiving video) to avoid the need to periodically distribute the library.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

The many features and advantages of the invention are apparent from the detailed specification. Thus, the appended claims are to cover all such features and advantages of the invention that fall within the true spirit and scope of the invention. Furthermore, since numerous modifications and variations will readily occur to those skilled in the art, it is not desired to limit the invention to the exact construction and operation illustrated and described. Accordingly, appropriate modifications and equivalents may be included within the scope.

What is claimed is:

1. A method for identifying repeating video sequences comprising:
determining a set of candidate video sequences from at least one video stream;
creating video fingerprints for subsequences of the candidate repeating video sequences;
comparing the video fingerprints of the subsequences of the candidate repeating video sequences against each other to create matched subsequences; and
grouping the matched subsequences as repeating video sequences.

2. The method of claim 1 further comprising:
presenting repeating video sequences to a viewer;
receiving viewer selections of repeating video sequences of interest; and
eliminating candidate repeating video sequences not of interest.

3. The method of claim 1 wherein the step of determining the set of candidate repeating video sequences is accomplished by feature based detection.

4. The method of claim 3 wherein the feature based detection is by monochrome frames.

5. The method of claim 3 wherein the feature based detection is by scene breaks.

6. The method of claim 3 wherein the feature based detection is by hard cuts.

7. The method of claim 3 wherein the feature based detection is by dissolves.

8. The method of claim 3 wherein the feature based detection is by fades.

9. The method of claim 3 wherein the feature based detection is by action changes.

10. The method of claim 3 wherein the feature based detection is by edge change ratio.

11. The method of claim 3 wherein the feature based detection is by motion length vector changes.

12. The method of claim 1 wherein the step of creating video fingerprints is accomplished by creating color histograms of the subsequences.

13. The method of claim 1 wherein the step of creating video fingerprints is accomplished by creating color coherence vectors of the subsequences.

14. The method of claim 12 wherein the color histograms are created from a sub-sampled representation of the subsequence.

15. The method of claim 13 wherein the color coherence vectors of the subsequences are created from a sub-sampled representation of the subsequence.

16. The method of claim 1 further comprising:
adding the repeating video sequence to a fingerprint library.

17. The method of claim 16 further comprising:
storing information associated with the repeating video sequence in the fingerprint library.

18. The method of claim 17 wherein the information associated with the repeating video sequence is channel information.

19. The method of claim 17 wherein the information associated with the repeating video sequence is advertisement break information.

20. The method of claim 19 wherein the advertisement break information is typical break duration information.

21. The method of claim 16 further comprising:
disseminating the fingerprint library to a plurality of clients.

22. A computer based system for automated detection of repeating video sequences comprising:
a subsystem for the feature based detection of candidate sequences;
a subsystem for the generation of video fingerprints from sequences of the candidate sequences;
a subsystem for the matching of video fingerprints of the candidate sequences; and
a subsystem for the isolation of repeating sequences based on matching of the video fingerprints of the candidate sequences.

23. The system of claim 22 wherein the subsystem for the feature based detection is further comprised of sequence detection software operating on a computing device for detecting hard cuts in a video stream.

24. The system of claim 22 wherein the subsystems for the generation and matching of video fingerprints is further comprised of color coherence vector software operating on a computing device for generating and matching color coherence vectors of sequences of the candidate sequences.

25. A computer based method for the creation of a library of repeating advertisements comprising:
creating a set of candidate sequences from an incoming video stream wherein the creating is done based on the presence of features within the incoming video stream;
creating a set of video fingerprints from subsequences of the candidate sequences;
comparing the set of video fingerprints against each other to determine matching subsequences; and
grouping the matching subsequences to create a repeating advertisement;

26. The computer based method of claim 25 further comprising the step of:
adding the repeating advertisement to the library of repeating advertisements.

27. A computer-based system to identify a repeating video sequence comprising:
means for determining a set of candidate repeating video sequences in at least one video stream;
means for creating video fingerprints for subsequences of the candidate repeating video sequences;
means for comparing the video fingerprints of the subsequences of the candidate repeating video sequences against each other to create matched subsequences; and
means for grouping the matched subsequences as the repeating video sequence.

28. The computer based system of claim 27 further comprising:
means for adding the repeating video sequence to a fingerprint library.

29. The computer based system of claim 27 further comprising:
means for distributing the fingerprint library.
